(19) United States
(12) Patent Application Publication
(10) Pub. No.: US 2007/0210578 A1
(43) Pub. Date: Sep. 13, 2007

(54) Hose Apparatus and Method of Manufacturing Same

(76) Inventor: Aaron David McKenny, Aylesbury (GB)

Correspondence Address: FAY SHARPE LLP, 1100 SUPERIOR AVENUE, SEVENTH FLOOR, CLEVELAND, OH, 44114, US

(21) Appl. No.: 10/578,488

(22) PCT Filed: Oct. 13, 2004
(86) PCT No.: PCT/GB04/04375

§ 371 Date: Dec. 18, 2006

(30) Foreign Application Priority Data
Nov. 7, 2003 (GB) 0326068.4

(51) Int. Cl. F16L 25/00

(52) U.S. Cl. 285/386

(57) ABSTRACT

A hose has a connector (12) at an end portion (10) thereof for providing a connection with a unit, the connector comprising a first moulded member (20) having an inner annular surface (22) moulded to an outer annular surface (24) of the end portion to provide a fluid-tight connection with the end portion, and a fastener (26) for fastening the connector to the unit. A method of manufacturing the hose comprises the steps of: inserting a core (80) inside the hose end portion (10) to support the hose end portion during moulding; moulding the first moulded member (20) with the inner annular surface (22) thereof moulded to an outer annular surface (24) of the end portion; withdrawing the core; and positioning the fastener (26) at the end portion for fastening the connector to the unit.

### FIELD OF THE INVENTION

The present invention relates to a hose having a connector at an end portion thereof for providing a connection with a unit for the supply of fluid.

### BACKGROUND TO THE INVENTION

A hose, or other fluid conduit, has many applications, such as the supply of water from a base unit to a shower head, the supply of water from a tap to a hose attachment, e.g. a sprinkler, or as part of a plumbing system. The present invention is particularly, although not exclusively, useful in the supply of fluid along a flexible hose.

A prior art shower hose is manufactured with a connector at one end thereof for connection with a shower head unit or shower base unit. The connector comprises at least one metal sleeve which is crimped around an outer annular surface of the end portion so that the sleeve mechanically engages with the end portion. A fastener, such as a conical nut is arranged to engage the sleeve and to fasten the sleeve to the unit. Suitable seals are incorporated in the connector for providing a water-tight connection, between the fastener and unit, and between the fastener and sleeve.

A disadvantage with the prior art arrangement is that when the sleeve is crimped to the hose end portion, the internal bore of the hose end portion is reduced in diameter and this affects the flow of fluid through the hose and into the unit. A further reduction in the diameter of the internal bore occurs because the connector connects the hose to the unit without allowing relative rotation between the hose and the unit. This results in a tendency for the hose to twist when the unit is moved, and particularly when the unit is rotated, which further reduces the diameter of the internal bore. When the hose is resilient, it resists against twisting, and therefore, resists free movement of the unit. In addition to these disadvantages, any reduction in the diameter of the internal bore may also result in pressure fluctuations at the showerhead such as to impair the overall performance of the system.

It is therefore desirable to provide a hose having a connector at an end portion thereof which alleviates at least one of the above-mentioned problems with the prior art.

### SUMMARY OF THE INVENTION

The present invention provides a hose having a connector at an end portion thereof for providing a connection with a unit, the connector comprising a first moulded member having an inner annular surface moulded to an outer annular surface of said end portion to provide a fluid-tight connection with the end portion, and a fastener for fastening the connector to the unit.

The hose may comprise a second moulded member, wherein said first moulded member is moulded between the second moulded member and the hose end portion so that an outer annular surface of the first moulded member corresponds in shape to an inner annular surface of the second moulded member to allow relative rotation between the first moulded member and the second moulded member, wherein the fastener is for fastening the second moulded member to the unit, and wherein, when the hose is connected to the unit, relative rotation between the hose and the unit is allowed.

The present invention also provides a method of manufacturing a hose having a connector at an end portion thereof for providing a connection with a unit, the method comprising the steps of:

inserting a core inside a hose end portion to support the hose end portion during moulding;

moulding a first moulded member with an inner annular surface thereof moulded to an outer annular surface of said end portion;

withdrawing said core; and

positioning a fastener at said end portion for fastening the connector to the unit.

The method may further comprise the steps of:

moulding a second moulding member prior to moulding the first moulding member;

positioning the second moulded member relative to the hose end portion so that the first moulded member is moulded between the second moulded member and the hose end portion so that an outer annular surface of the first moulded member corresponds in shape to an inner annular surface of the second moulded member to allow relative rotation between the first moulded member and the second moulded member;

positioning the fastener at said end portion for fastening the second moulded member to a unit.

The present invention also provides a shower assembly comprising:

a shower base unit;

a shower head unit;

and a hose as claimed in any of claims 1 to 9 having a first said connector at one said end portion thereof for providing a connection with the shower base unit; and a second said connector at an opposing said end portion thereof for providing a connection with the shower head unit, for allowing the supply of water from the shower base unit to the shower head unit.

The present invention also provides shower assembly comprising:

a shower base unit;

a shower head unit;

and a hose for the supply of water from the shower base unit to the shower head unit, the hose having a connector at an end portion thereof for providing a connection with the shower head unit;

wherein the connector comprises: a first moulded member and a second moulded member, the first moulded member being moulded between the second moulded member and the hose end portion, the first moulded member having:

an inner annular surface moulded to an outer annular surface of said end portion to provide a fluid-tight connection with the end portion; and

an outer annular surface which corresponds in shape to an inner annular surface of the second moulded member to allow relative rotation between the first moulded member and the second moulded member,

wherein the connector further comprises a fastener for fastening the second moulded member to the shower head unit, and wherein, when the hose is connected to the shower head unit, relative rotation between the hose and the shower head unit is allowed.

### BRIEF DESCRIPTION OF THE DRAWINGS

In order that the present invention may be well understood, an embodiment thereof, which is given by way of example only, will now be described with reference to the accompanying drawings, in which:

FIG. 1 shows a cross-section of a hose having a first connector at an end portion thereof;

FIG. 2 shows a cross-section of a hose having a second connector at an end portion thereof;

FIGS. 3 to 8 show method steps in manufacturing a hose as shown in FIGS. 1 and 2;

FIG. 9 shows a moulding tool for manufacturing a hose as shown in FIGS. 1 and 2; and

FIG. 10 shows a hose having a modified connector at an end portion thereof.

### DESCRIPTION OF THE PREFERRED EMBODIMENTS

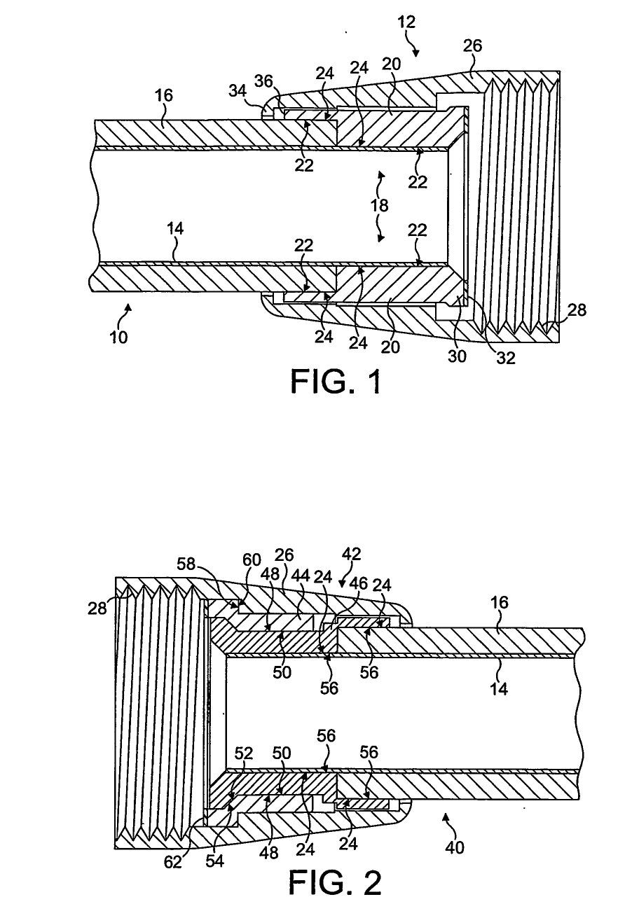

Referring to FIG. 1, a hose end portion 10 is shown having a connector 12 for providing a connection with a unit, such as a shower base unit (not shown). The hose, of which only the end portion 10 is shown, comprises an inner tube 14 for the passage of fluid and an outer sleeve 16 for providing support for the inner tube. The outer sleeve comprises a helically wound coil usually of metal surrounded by a plastics sheath. Thus, the sleeve resists the inner tube from collapsing inwardly during use. At the tip 18 of the hose, outer sleeve 16 is pared back to expose the inner tube 14.

Connector 12 comprises a first moulded member 20 having an inner annular surface 22 moulded to an outer annular surface 24 of the hose end portion 10 to provide a fluid-tight connection with the end portion. As shown, to provide a secure connection between the first moulded member 20 and the hose end portion 10, the inner annular surface 22 of the first moulded member 20 is moulded to the outer annular surface 24 of both the inner tube 14 (at the tip of the hose) and the outer sleeve 16 adjacent the tip 18.

A fastener 26, in the form of a conical nut, is positioned for fastening the connector to a unit Fastener 26 has a threaded internal bore 28 for engaging with a threaded sleeve of a port in the unit. The first moulded member 20 has a flared end 30 to which an annular seal 32 is seated. When the fastener engages with the unit, an inwardly extending shoulder 34 engages with an annular end face 36 of the first moulded member 20 to urge the annular seal 32 into abutment with a complementary sealing surface in the unit. When connected to the unit, the hose is not rotatable relative to the unit. The bond between the first moulded member 20 and the inner tube 14 and outer sleeve 16 ensures a fluid-tight connection therebetween and the annular seal 32 ensures a fluid-tight connection between the first moulded member 20 and the unit. As will be explained in more detail below, the inner tube 14 is supported by a core during moulding of the first moulded member 20 thereto, and therefore, the internal bore of the inner tube is not reduced during manufacture and hence the fluid flow passage defined by inner tube 14 is not restricted.

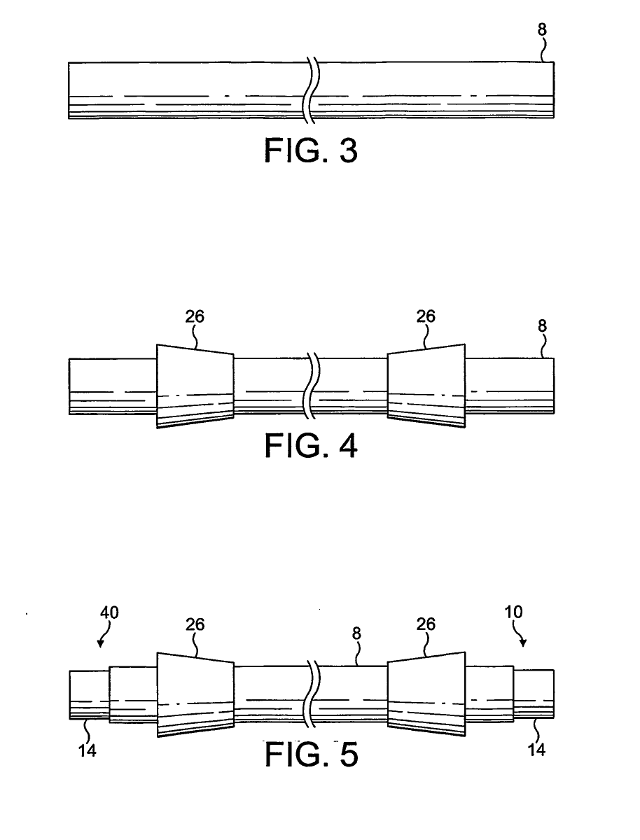

An opposing end portion 40 of the hose is shown in FIG. 2. The opposing end portion has a connector 42 for providing a connection with a unit, such as a shower head unit. The fastener 26 is the same as fastener 26 in FIG. 1. The hose, similarly, has an inner tube 14 and an outer sleeve 16. The inner tube 14 is pared back at its tip end prior to moulding.

As will be described in more detail below, a second moulded member 44 is moulded prior to moulding a first moulded member 46. After moulding, the second moulded member 44 is positioned relative to the hose end portion 40 so that the first moulded member is moulded between the second moulded member and the inner tube 14 of the hose end portion 40 so that an outer annular surface 48 of the first moulded member 46 corresponds in shape to an inner surface 50 of the second moulded member 44. This arrangement allows relative rotation between the first moulded member and the second moulded member. Further, the first moulded member 46 has an outwardly tapering surface 52 which corresponds in shape to an inwardly tapering surface 54 of the second moulded member. This arrangement resists axial movement of the second moulded member relative to the first moulded member. In a similar way to the FIG. 1 arrangement, the first moulded member 46 is moulded having an inner annular surface 56 moulded about an outer annular surface 24 of the hose end portion 40, to provide a fluid-tight fit between the first moulded member 46 and the hose end portion 40. The fastener 26 is positioned about the first and second moulded members 44, 46, and fastens the connector to a shower head unit by engaging the threaded bore 28 with a complementary screw fitting on the shower head unit. The fastener 26 has an annular end face 58 which engages an annular end face 60 of the second moulded member 44 to urge an annular seal 62 into abutment with a complementary sealing surface in the shower head unit to create a fluid-tight connection between the shower head unit and the second moulded member 44.

The second moulded member 44 which is fixed relative to the shower head unit is allowed to rotate relative to the first moulded member 46 which is fixed relative to the hose. Accordingly, rotational movement of the shower head unit does not cause twisting of the hose, and therefore, the internal bore of inner tube 14 is not reduced during use of the shower. Further, similarly to the FIG. 1 arrangement, a core is inserted in the inner tube 14 during manufacture so that when the first moulded member 46 is moulded thereto, the internal bore of inner tube 14 is not reduced as a result of the moulding process.

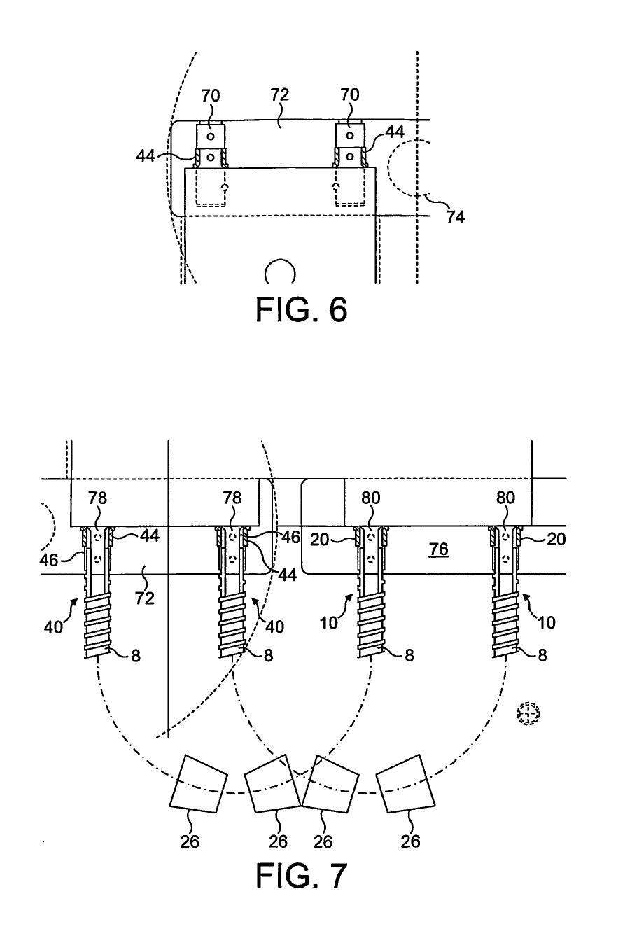

A method of manufacturing the previously described hose with first and second end portions will now be described with reference to FIGS. 3 to 9. A hose which may be stored on a reel or reels is cut to length as shown in FIG. 3. Fasteners 26, or conical nuts as shown, are assembled over the hose as shown in FIG. 4. The tip end of hose end portions 10 and 40 are pared back to expose inner tube 14, as shown in FIG. 5.

FIG. 6 shows a step in the manufacture of the connector 42 at hose end portion 40. The manufacturing method is described in relation to the manufacture of two hoses simultaneously. The method can be modified to manufacture a single hose or more than two hoses simultaneously as required.

In FIG. 6, two cores 70 have been introduced to a moulding tool 72. Second moulding members 44 are then moulded about cores 70. Once moulded, moulding tool 72 is rotated through 180° about pivot 74 to the position shown in FIG. 7. Cores 70 may be withdrawn prior to rotation or afterwards.

FIG. 7 shows two hoses 8 extending between moulding tools 72 and 76. As previously indicated, moulding tool 72 is for manufacturing connector 42 at hose end portion 40. Moulding tool 76 is for manufacturing connector 12 at hose end portion 10. Broken lines indicate the arrangement of the hoses 8 between moulding tools 72 and 76.

Once cores 70 have been withdrawn, cores 78 are introduced radially inwardly of second moulded member 44 and hose end portion 40 is passed over cores 78. First moulded member 46 is then moulded between the second moulded member 44 and the hose end portion 40. The first moulded members 46 are moulded with inner annular surfaces 56 moulded to outer annular surfaces 24 of hose end portion 40. Outer annular surfaces 48 of first moulded member 46 are moulded to correspond in shape to the inner annular surfaces 50 of the second moulded member 44 to allow relative rotation between the first moulded member and the second moulded member.

Once moulding is complete, cores 78 are withdrawn and hose end portions 40 are removed from moulding tool 72. Fastener 26 can then be positioned at hose end portion 40 for fastening connector 42 to a unit.

Simultaneously or consecutively, connector 12 at hose end portion 10 is manufactured on moulding tool 76. As shown, cores 80 are inserted in the internal bore of tube 14 at hose end portion 10. First moulded member 20 is then moulded about end portion 10 and inner annular surface 22 of first moulded member 20 is moulded about outer annular surface 24 of hose end portion 10. The first moulded member 20 is moulded about both the inner tube 14 and outer sleeve 16 to further ensure a fluid-tight connection between the first moulded member and hose end-portion 10. Subsequently, cores 80 are withdrawn and fasteners 26 are positioned for fastening the connector 12 to a unit.

As shown in FIG. 8, annular seals 32 and 62 are introduced axially to connectors 12, 42, respectively, prior to securing each of the connectors 12, 42 to their respective mountings. Whilst the seals 32, 62 are preferably provided loose, they may alternatively be bonded in place to the first moulded member 20 and the second moulded member 44, respectively.

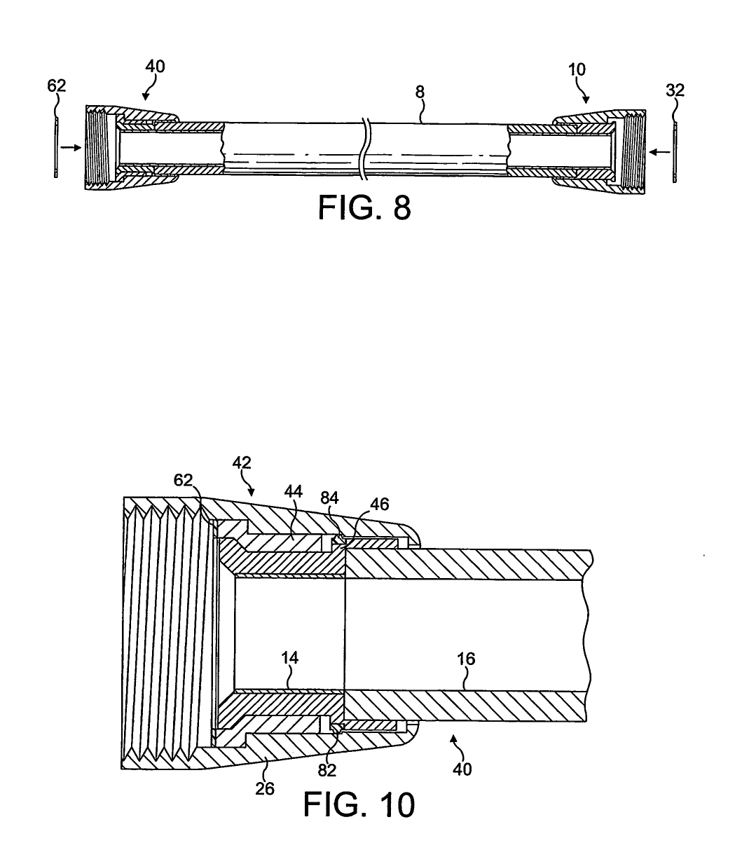

For ease of understanding, moulding tool 72 is shown in its entirety in FIG. 9. In FIG. 9 it can be appreciated that the manufacturing method as described readily submits itself to the production of large numbers of hoses in a short time span. In this regard, the step of moulding second moulded member 44 can be carried out at the same time as the moulding of first moulded member 46.

In the manufacture of connectors 12 and 42, first moulded member 20, 46 is moulded using the inner tube 14 and outer sleeve 16 as part of the mould therefor. Additionally, in connector 42, first member 44 also forms part of the mould for first moulded member 46. In this way, the manufacturing process is efficient and the cooperation between the components can be insured at low cost. In more detail, the connection between the first moulded member and the hose end portion must be fluid-tight and this is achieved because the first moulded member is moulded to the hose end portion. In connector 42, relative rotation is required between the second moulded member 44 and the first moulded member 46. This is achieved in the present manufacturing process by ensuring that an annular interface is provided between members 46 and 44. In previous techniques, the corresponding surfaces of two components would have to be manufactured with very high tolerances to allow a connection which both allows relative rotation and which provides a sealing effect against fluid seepage.

During moulding of first moulded members 20 and 46, cores 80 and 78, respectively, support the inner tube 14 and prevent it from deforming radially inwardly. Accordingly, the internal bore of tube 14 is not reduced in size and thus flow in internal bore 14 is not restricted.

Although the present hose 8 has been described with a connector 12 at one end portion thereof and a connector 42 at an opposing end portion thereof, the invention is not restricted to this arrangement. Instead, a rotatable connector 42 can be provided at both end portions of the hose, or a static connector 12 can be provided at both end portions of the hose. It is further envisaged that a hose could be provided with a connector 12 or a connector 42 at one end portion thereof and no such connector at an opposing end portion thereof.

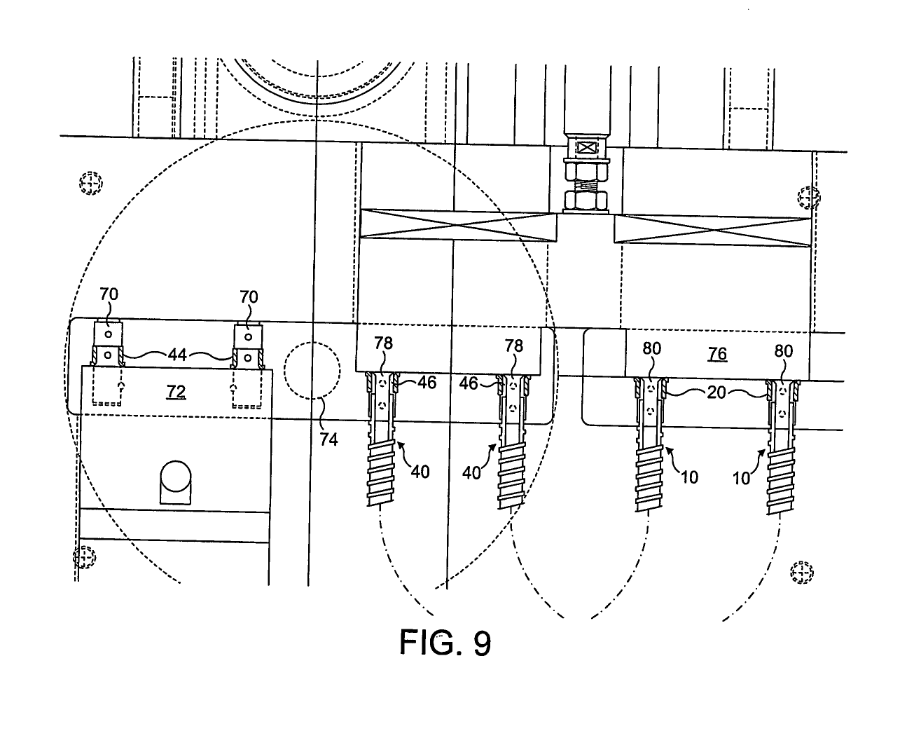

In addition to the hose 8 described above, a further modification is shown in FIG. 10. FIG. 10 illustrates connector 42 at hose end portion 40. An additional manufacturing step provides a moulded annular sealing member 82 positioned between fastener 26 and an outer annular surface 84 of first moulded member 46. The annular sealing member 82 can be moulded using the over annular surface 84 as a moulding part. Member 82 further ensures sealing between the fastener 26 and first moulded member 46. Although sealing member 82 has been described with reference to connector 42, it would also be possible to provide a moulded sealing member in connector 12.

1. A hose comprising:
a connector at an end portion of the hose for providing a connection with a an associated unit, the connector including a first molded member having an inner annular surface molded to an outer annular surface of said end portion to provide a fluid-tight connection with the end portion; and,
a fastener for fastening the connector to the associated unit.

2. A hose according to claim 1, wherein the fastener is configured to fasten the first molded member to the associated unit.

3. A hose according to claim 1, wherein the connector further includes a second molded member, wherein said first molded member is molded between the second molded member and the hose end portion so that an outer annular surface of the first molded member corresponds in shape to an inner annular surface of the second molded member to allow relative rotation between the first molded member and the second molded member, wherein the fastener is configured to fasten the second molded member to the unit, and wherein, when the hose is connected to the unit, relative rotation between the hose and the unit is allowed.

4. A hose according to claim 3, wherein the outer annular surface of the first molded member is molded against the inner annular surface of the second molded member to provide a fluid-tight connection therebetween.

5. A hose according to claim 4, further including an annular seal molded about the first molded member for sealing an annular space between the first molded member and the fastener.

6. A hose according to claim 5 further including an inner tube for the passage of fluid and an outer sleeve for providing support for the inner tube, and wherein the inner annular surface of the first molded member is molded to an outer annular surface of both the inner tube and the outer sleeve.

7. A hose according to claim 3 further including a second connector at an opposing end hose portion thereof for providing a connection with a second associated unit at the opposing end portion.

8. A hose according to claim 7, wherein at least one of said end portion and said opposing end portion has a said connector which allows relative rotation between the hose and the unit when connected to the unit.

9. A hose according to claim 8, wherein the connector is configured for connecting the hose to an attachment for relative rotation between the attachment and the hose.

10. A method of manufacturing a hose having a connector at an end portion thereof for providing a connection with an associated unit, the method comprising the steps of:
inserting a core inside a hose end portion to support the hose end portion during molding;
molding a first moulded member with an inner annular surface thereof molded to an outer annular surface of said end portion;
withdrawing said core; and,
positioning a fastener at said end portion for fastening the connector to the unit.

11. A method according to claim 10, further comprising the steps of:
molding a second moulding member prior to molding the first molding member;
positioning the second molded member relative to the hose end portion so that the first molded member is molded between the second molded member and the hose end portion so that an outer annular surface of the first molded member corresponds in shape to an inner annular surface of the second molded member to allow relative rotation between the first molded member and the second molded member; and,
positioning the fastener at said end portion for fastening the second molded member to a unit.

12. A method according to claim 10, further comprising the step of:
molding an annular seal about the first molded member for sealing an annular space between the first molded member and the fastener.

13. A shower assembly comprising:
a shower base unit;
a shower head unit; and,
a hose as claimed in any of claims 1 to 9 having a first said connector at one said end portion thereof for providing a connection with the shower base unit; and a second connector at an opposing said end portion thereof for providing a connection with the shower head unit, for allowing the supply of water from the shower base unit to the shower head unit.

14. A shower assembly comprising:
a shower base unit;
a shower head unit; and,
a hose for the supply of water from the shower base unit to the shower head unit, the hose having a connector at an end portion thereof for providing a connection with the shower head unit;
wherein the connector comprises: a first moulded member and a second molded member, the first molded member being molded between the second molded member and the hose end portion, the first molded member having:
an inner annular surface molded to an outer annular surface of said end portion to provide a fluid-tight connection with the end portion; and,
an outer annular surface which corresponds in shape to an inner annular surface of the second molded member to allow relative rotation between the first molded member with the second molded member,
wherein the connector further comprises a fastener for fastening the second molded member to the shower head unit, and wherein, when the hose is connected to the shower head unit, relative rotation between the hose and the shower head unit is allowed.

15. An apparatus in combination comprising:
a hose member;
a connector at a first end portion of the hose member for providing a connection with an associated first unit, the connector including a first molded member having an inner annular surface molded to an outer annular surface of said first end portion to provide a fluid-tight connection with the first end portion; and,
a fastener for fastening the connector to the associated first unit.

16. The apparatus according to claim 15, wherein the first molded member is attached with the associated first unit by said fastener.

17. The apparatus according to claim 16, wherein:
the connector further includes a second molded member, said first molded member being molded between the second molded member and the hose end portion so that an outer annular surface of the first molded member corresponds in shape to an inner annular surface of the second molded member to allow relative rotation between the first molded member and the second molded member; and,
the fastener is configured to fasten the second molded member to the unit, and wherein, when the hose is connected to the unit, relative rotation between the hose and the unit is enabled.

18. The apparatus according to claim 17, wherein the outer annular surface of the first molded member is molded against the inner annular surface of the second molded member to provide a fluid-tight connection therebetween.

19. The apparatus according to claim 18, further including an annular seal molded about the first molded member for sealing an annular space between the first molded member and the fastener.

20. The apparatus according to claim 16, wherein said hose member includes an inner tube for the passage of fluid and an outer sleeve for providing support for the inner tube, and wherein the inner annular surface of the first molded member is molded to an outer annular surface of both the inner tube and the outer sleeve.

21. The apparatus according to claim 17, further including a second connector at an opposing end hose portion thereof for providing a connection with a second associated unit at the opposing end portion, wherein at least one of said end portion and said opposing end portion has a said connector which allows relative rotation between the hose and the unit when connected to the unit, and, wherein the connector is configured for connecting the hose to an attachment for relative rotation between the attachment and the hose.
